(19) United States
(12) Patent Application Publication
(10) Pub. No.: US 2016/0036621 A1
(43) Pub. Date: Feb. 4, 2016

(54) MANAGEMENT SYSTEM AND MANAGEMENT METHOD

(71) Applicant: Cameo Communications, Inc., Taipei City (TW)

(72) Inventor: Ming-Hsien YU, Taipei City (TW)

(21) Appl. No.: 14/555,349

(22) Filed: Nov. 26, 2014

(30) Foreign Application Priority Data
Aug. 1, 2014 (TW) 103126437

(51) Int. Cl. H04L 12/24; H04L 29/08

(52) U.S. Cl. CPC H04L 41/0213; H04L 29/08756

(57) ABSTRACT

A management system is applicable to an electronic apparatus. The management system includes at least one first transceiving module, a comparing module and a processing module. The first transceiving module is configured for receiving first input data inputted from a corresponding first input/output interface, and for outputting second input data according to the first input data. The comparing module is configured for receiving the second input data, for comparing the second input data with a plurality of first mapping data in a database, for converting the second input data to third input data according to a first comparison result, and for outputting the third input data. The processing module is configured for receiving the third input data, and for converting the third input data to fourth input data such that the electronic apparatus performs corresponding operations according to the fourth input data. A management method is disclosed herein as well.

### RELATED APPLICATIONS

This application claims priority to Taiwan Application Serial Number 103126437, filed Aug. 1, 2014, the entirety of which is herein incorporated by reference.

### BACKGROUND

1. Technical field

The present disclosure relates to a management system. More particularly, the present disclosure relates to a management system and a management method capable of integrating different management protocols or interfaces.

2. Description of Related Art

Conventionally, when a network administrator or a software developer is managing or operating an electronic apparatus, the management protocol or interface of the electronic apparatus is utilized to perform firmware settings, function settings or data inquiring. There are plenty of management protocols and interfaces including WEB interface, command-line interface (CLI), Telnet interface, simple network management protocol (SNMP) and CPE WAN management protocol (TR069).

Therefore, an electronic apparatus needs to disposed with different receiving and processing modules corresponding to the abovementioned management interfaces. For example, when a network administrator would like to operate an electronic communication equipment by utilizing a WEB interface, the communication equipment has to be disposed with a HTTP server and a corresponding common gateway interface (CGI). When a network administrator would like to operate an electronic communication equipment by utilizing a CLI interface, the communication equipment has to be disposed with a CLI engine and a corresponding common gateway interface.

Since the management interfaces and protocols are different, and are not able to support or share with each other, the complexity of the electronic apparatus is raised accordingly. Moreover, the configuration manager utilized to perform firmware setup inside the electronic apparatus also needs to disposed with complicated structures to process the data exchange due to the abovementioned different management interfaces and protocols. Therefore, it is not convenient to implement and maintain the software as well as the hardware of the electronic apparatus.

### SUMMARY

In one aspect, the present disclosure is related to a management system applicable to an electronic apparatus. The management system includes at least one first transceiving module, a comparing module and a processing module. The first transceiving module is configured for receiving first input data inputted from a corresponding first input/output interface, and for outputting second input data according to the first input data. The comparing module is configured for receiving the second input data, for comparing the second input data with a plurality of first mapping data in a database, for converting the second input data to third input data according to a first comparison result, and for outputting the third input data. The processing module is configured for receiving the third input data, and for converting the third input data to fourth input data such that the electronic apparatus performs corresponding operations according to the fourth input data.

According to one embodiment of the present disclosure, the third input data and the fourth input data are management information base (MIB) data.

According to another embodiment of the present disclosure, the processing module is further configured for converting first output data to second output data, and for outputting the second output data. The comparing module is further configured for receiving the second output data, for comparing the second output data with a plurality of second mapping data in the database, for converting the second output data to third output data according to a second comparison result, and for outputting the third output data. The first transceiving module is further configured for receiving the third output data, and for outputting fourth output data to the corresponding first input/output interface according to the third output data.

According to still another embodiment of the present disclosure, the processing module includes a setup module and a reading module. The setup module is configured for transmitting the fourth input data to a configuration manager of the electronic apparatus such that the configuration manager adjusts a firmware setup or a function setup of the electronic apparatus according to the fourth input data. The reading module is configured for reading the first output data from the electronic apparatus by utilizing the configuration manager.

According to yet another embodiment of the present disclosure, the first transceiving module includes a converting module. The converting module is configured for converting the first input data to the second input data, and for converting the third output data to the fourth output data, wherein the second input data and the third output data are described in JavaScript Object Notation (JSON) data-interchange format.

According to still yet another embodiment of the present disclosure, the processing module includes a validation module. The validation module is configured for determining if the third input data follow a rule for input values. If not, the validation module outputs an error message by utilizing the second output data.

According to another embodiment of the present disclosure, the first input/output interface is a WEB interface, a command-line interface (CLI) or a Telnet interface.

According to still another embodiment of the present disclosure, the management system further includes at least one second transceiving module. The second transceiving module is configured for receiving fifth input data inputted from a corresponding second input/output interface, and for outputting sixth input data according to the fifth input data, wherein the processing module is further configured for converting the sixth input data to the fourth input data.

According to yet another embodiment of the present disclosure, the processing module is further configured for converting fifth output data to sixth output data, and for outputting the sixth output data. The second transceiving module is further configured for receiving the sixth output data, and for outputting seventh output data to the corresponding second input/output interface according to the sixth output data.

According to still yet another embodiment of the present disclosure, the second transceiving module includes a converting module. The converting module is configured for converting the fifth input data to the sixth input data, and for converting the sixth output data to the seventh output data, in which the sixth input data and the sixth output data are management information base data.

According to another embodiment of the present disclosure, the second transceiving module is a simple network management protocol (SNMP) interface or a CPE WAN management protocol (TR069) interface.

In another aspect, the present disclosure is related to a management method applicable to an electronic apparatus. The management method includes: receiving first input data inputted from a corresponding first input/output interface, and outputting second input data according to the first input data; comparing the second input data with a plurality of first mapping data in a database, converting the second input data to third input data according to a first comparison result, and outputting the third input data; and receiving the third input data, and converting the third input data to fourth input data such that the electronic apparatus performs corresponding operations according to the fourth input data.

According to one embodiment of the present disclosure, the third input data and the fourth input data are management information base data.

According to another embodiment of the present disclosure, the management method further includes: converting first output data to second output data, and outputting the second output data; comparing the second output data with a plurality of second mapping data in the database, converting the second output data to third output data according to a second comparison result, and outputting the third output data; and receiving the third output data, and outputting fourth output data to the corresponding first input/output interface according to the third output data.

According to still another embodiment of the present disclosure, receiving the third input data, and converting the third input data to the fourth input data such that the electronic apparatus performs corresponding operations according to the fourth input data further includes: transmitting the fourth input data to a configuration manager of the electronic apparatus such that the configuration manager adjusts a firmware setup or a function setup of the electronic apparatus according to the fourth input data.

According to yet another embodiment of the present disclosure, receiving the first input data inputted from the corresponding first input/output interface, and outputting the second input data according to the first input data further includes: converting the first input data to the second input data, in which the second input data are described in JavaScript Object Notation data-interchange format; and receiving the third output data, and outputting the fourth output data to the corresponding first input/output interface according to the third output data further includes: converting the third output data to the fourth output data, wherein the third output data are described in JavaScript Object Notation data-interchange format.

According to still yet another embodiment of the present disclosure, the management method further includes: determining if the third input data follow a rule for input values, and if not, outputting an error message by utilizing the second output data.

According to another embodiment of the present disclosure, the first input/output interface is a WEB interface, a command-line interface or a Telnet interface.

According to still another embodiment of the present disclosure, the management method further includes: receiving fifth input data inputted from a corresponding second input/output interface, and outputting sixth input data according the fifth input data; and converting the sixth input data to the fourth input data such that the electronic apparatus performs corresponding operations according to the fourth input data.

According to yet another embodiment of the present disclosure, the management method further includes: converting fifth output data to sixth output data, and outputting the sixth output data; and receiving the sixth output data, and outputting seventh output data to the corresponding second input/output interface according to the sixth output data.

According to still yet another embodiment of the present disclosure, the second transceiving module is a simple network management protocol interface or a CPE WAN management protocol interface.

By applying the management system disclosed in the present disclosure, the management program developed by software engineers could be used to manage or maintain electronic apparatus by utilizing different management protocols or interfaces. Moreover, the management system disclosed in the present disclosure could integrate different management protocols or interfaces and provide a single interface to correspond to the configuration manager of the system. Therefore, the complicity of the system core of the electronic apparatus can be reduced.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a management system in accordance with one embodiment of the present disclosure;

FIG. 2 is a schematic diagram of a management system in accordance with another embodiment of the present disclosure;

FIG. 3 is a schematic diagram of a management system in accordance with still another embodiment of the present disclosure;

FIG. 4 is a schematic diagram of a management system in accordance with yet another embodiment of the present disclosure;

FIG. 5 is a schematic diagram of a management system in accordance with still yet another embodiment of the present disclosure;

FIG. 6 is a flow chart of a management method in accordance with one embodiment of the present disclosure;

FIG. 7 is a flow chart of a management method in accordance with another embodiment of the present disclosure;

FIG. 8 is a flow chart of a management method in accordance with still another embodiment of the present disclosure;

FIG. 9 is a flow chart of a management method in accordance with yet another embodiment of the present disclosure; and

FIG. 10 is a flow chart of a management method in accordance with still yet another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

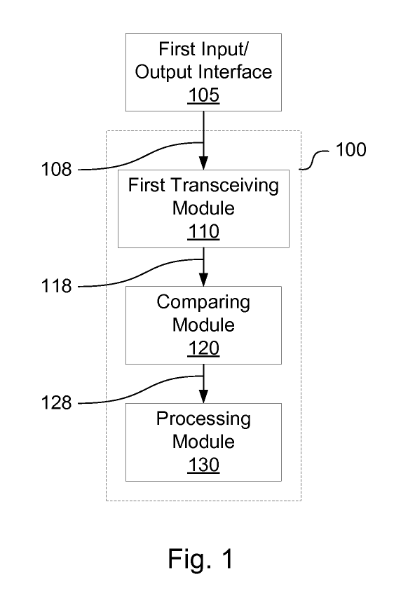

Reference is made first to FIG. 1. FIG. 1 is a schematic diagram of a management system 100 in accordance with one embodiment of the present disclosure. The management system 100 is applicable to an electronic apparatus. The abovementioned electronic apparatus can be a communication equipment, for example, a router, a modem or a switch, but is not limited thereto. The management system 100 includes at least one first transceiving module 110, a comparing module 120 and a processing module 130.

The first transceiving module 110 is configured for receiving first input data 108 inputted from a corresponding first input/output interface 105, and for outputting second input data 118 according to the first input data 108.

The first input/output interface 105 can be included in a computer system (e.g., a desktop computer or a laptop computer) or a handheld electronic device (e.g., a smart phone or a tablet computer), but is not limited thereto. The first input/output interface 105 and the first transceiving module 110 can be connected in wire or wirelessly.

According to one embodiment of the present disclosure, the abovementioned electronic apparatus includes one or more processors and memory. The first transceiving module 110 is stored in the memory and configured for execution by the one or more processors.

According to one embodiment of the present disclosure, the first input/output interface 105 is a WEB interface, a command-line interface (CLI) or a Telnet interface. In another embodiment of the present disclosure, the first input data 108 are converted from WEB data, and are described in JavaScript Object Notation (JSON) data-interchange format, and the second input data 118 are the same as the first input data 108.

According to still another embodiment of the present disclosure, the first transceiving module 110 includes a converting module (not depicted). The abovementioned converting module is configured for converting the first input data 108 to the second input data 118. In one embodiment of the present disclosure, the first input data 108 are command-line interface data or Telnet data, and the abovementioned converting module is configured for the command-line interface data or the Telnet data to the second input data 118 which are described in JavaScript Object Notation data-interchange format.

In one embodiment of the present disclosure, the first transceiving module 110 includes at least one application programming interface (API). The application programming interface is configured for receiving the first input data 108, and for outputting the second input data 118.

The comparing module 120 is configured for receiving the second input data 118, for comparing the second input data 118 with a plurality of first mapping data in a database, for converting the second input data 118 to third input data 128 according to a first comparison result, and for outputting the third input data 128. In an embodiment of the present disclosure, the abovementioned electronic apparatus includes memory and one or more processors. The comparing module 120 is stored in the memory and configured for execution by the one or more processors.

To be more specific, each of the abovementioned first mapping data is configured for storing a mapping between the second input data 118 and the third input data 128. The information included in the second input data 118 can be converted to corresponding information of the third input data 128 by utilizing the abovementioned mappings. In one embodiment of the present disclosure, the third input data 128 are management information base (MIB) data.

In an example, the second input data 118 are converted from WEB data, and are described in JavaScript Object Notation data-interchange format. The comparing module 120 converts the second input data 118 to the third input data 128 which are described in data are management information base format according to the plurality of first mapping data in the database.

The processing module 130 is configured for receiving the third input data 128, and for converting the third input data 128 to fourth input data (not depicted) such that the abovementioned electronic apparatus performs corresponding operations according to the fourth input data. In an embodiment of the present disclosure, the abovementioned electronic apparatus includes memory and one or more processors. The processing module 130 is stored in the memory and configured for execution by the one or more processors.

In another embodiment of the present disclosure, the abovementioned fourth input data are data are management information base data. The abovementioned electronic apparatus performs a firmware setup or a function setup of the electronic apparatus, or inquiring and outputting data stored in the electronic apparatus according to the fourth input data.

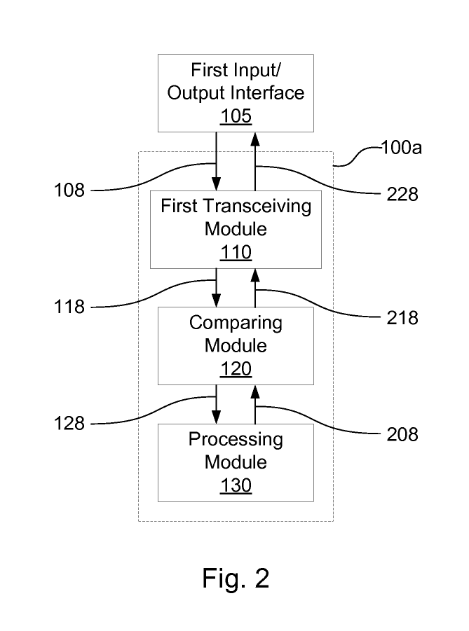

Reference is made also to FIG. 2. FIG. 2 is a schematic diagram of a management system 100a in accordance with one embodiment of the present disclosure. The management system 100a is applicable to an electronic apparatus. The abovementioned electronic apparatus can be a communication equipment, for example, a router, a modem or a switch, but is not limited thereto. Compared with the management system 100 illustrated in FIG. 1, in the present embodiment, the processing module 130 is further configured for converting first output data (not depicted) to second output data 208, and for outputting the second output data 208. The comparing module 120 is further configured for receiving the second output data 208, for comparing the second output data 208 with a plurality of second mapping data in the database, for converting the second output data 208 to third output data 218 according to a second comparison result, and for outputting the third output data 218. The first transceiving module 110 is further configured for receiving the third output data 218, and for outputting fourth output data 228 to the corresponding first input/output interface 105 according to the third output data 218.

In one embodiment of the present disclosure, the abovementioned electronic apparatus inquires data stored in the electronic apparatus according to the fourth input data, and outputs a inquiring result by utilizing the first output data such that a user or other electronic apparatuses could obtain the abovementioned inquiring result by utilizing the first input/output interface 105 to receive the fourth output result 228 corresponding to the abovementioned first output data. In another embodiment of the present disclosure, the abovementioned electronic apparatuses performs a firmware setup or a function setup according to the abovementioned fourth input data, and outputs a confirmation message or a status message by utilizing the abovementioned first output data. Therefore, a user or other electronic apparatuses could obtain the abovementioned confirmation message or status message by utilizing the first input/output interface 105 to receive the fourth output result 228 corresponding to the abovementioned first output data.

In another embodiment of the present disclosure, the processing module 130 includes a validation module (not depicted). The abovementioned validation module is configured for determining if the third input data 128 follow a rule for input values. If not, the validation module outputs an error message by utilizing the second output data 208. In an example, the third input data 128 includes a function-setup parameter, which is configured for adjusting the function setups of the electronic apparatus. The abovementioned validation module is configured for determining if the abovementioned function-setup parameter of the third input data 128 is within a range of numeric values. If the abovementioned function-setup parameter is not within the range of numeric values, the abovementioned validation module outputs an error message by utilizing the second output data 208.

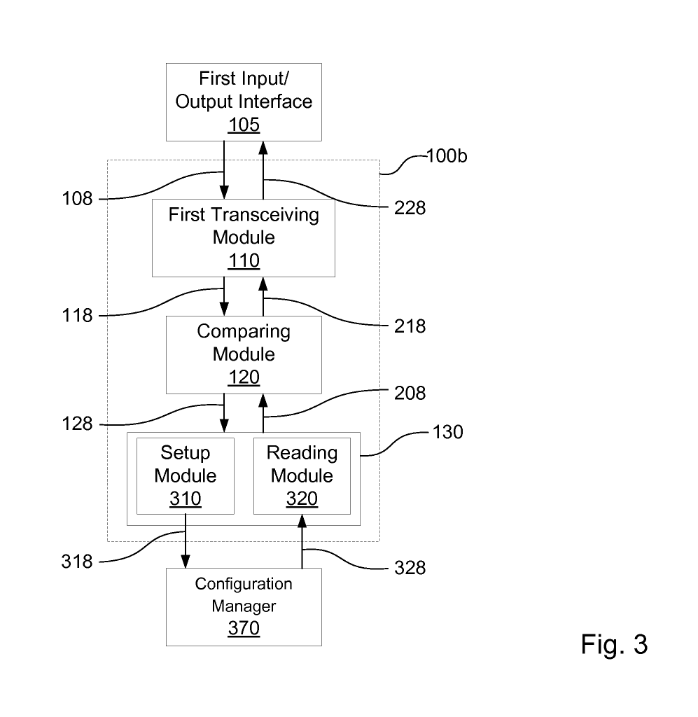

Additional reference is made to FIG. 3. FIG. 3 is a schematic diagram of a management system 100b in accordance with one embodiment of the present disclosure. The management system 100b is applicable to an electronic apparatus. The abovementioned electronic apparatus can be a communication equipment, for example, a router, a modem or a switch, but is not limited thereto. Compared with the management system 100a illustrated in FIG. 2, in the present embodiment, the processing module 130 further includes a setup module 310 and a reading module 320. As shown in FIG. 3, data 318 correspond to the fourth input data of the previous embodiment, and data 328 correspond to the first output data of the previous embodiment. In an embodiment of the present disclosure, the abovementioned electronic apparatus includes memory and one or more processors. The setup module 310 and the reading module 320 are stored in the memory and configured for execution by the one or more processors.

The setup module 310 is configured for transmitting the fourth input data 318 to a configuration manager 370 of the electronic apparatus such that the configuration manager 370 adjusts a firmware setup or a function setup of the electronic apparatus according to the fourth input data 318. In another embodiment of the present disclosure, the abovementioned electronic apparatus includes memory and one or more processors. The configuration manager 370 is stored in the memory and configured for execution by the one or more processors.

The reading module 320 is configured for reading the first output data 328 from the electronic apparatus by utilizing the configuration manager 370. In an example, the abovementioned electronic apparatus is a communication equipment, the setup module 310 transmits the fourth input data 318 to the configuration manager 370 such that the configuration manager 370 adjusts a network connection data setup of the communication equipment. The reading module 320 reads the adjusted network connection data setup from the communication equipment, and the adjusted network connection data setup is included in the first output data 328.

In another embodiment of the present disclosure, the first transceiving module 110 includes a converting module (not depicted). The converting module is configured for converting the third output data 218 to the fourth output data 228. In an example, the third output data 218 are described in JavaScript Object Notation data-interchange format, and the abovementioned converting module is configured for converting the third output data 218 to the fourth output data 228, which are command-line interface data or Telnet interface data.

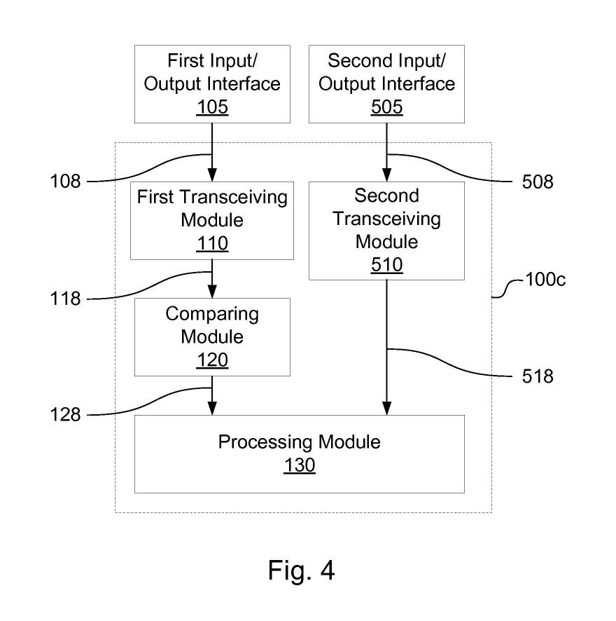

Reference is now made to FIG. 4. FIG. 4 is a schematic diagram of a management system 100c in accordance with one embodiment of the present disclosure. The management system 100c is applicable to an electronic apparatus. The abovementioned electronic apparatus can be a communication equipment, for example, a router, a modem or a switch, but is not limited thereto. Compared with the management system 100 illustrated in FIG. 1, in the present embodiment, the management system 100c further includes at least one second transceiving module 510. The second transceiving module 510 is configured for receiving fifth input data 508 inputted from a corresponding second input/output interface 505, and for outputting sixth input data 518 according to the fifth input data 508.

The second input/output interface 505 can be included in a computer system (e.g., a desktop computer or a laptop computer) or a handheld electronic device (e.g., a smart phone or a tablet computer), but is not limited thereto. The second input/output interface 505 and the second transceiving module 510 can be connected in wire or wirelessly.

According to one embodiment of the present disclosure, the abovementioned electronic apparatus includes one or more processors and memory. The second transceiving module 510 is stored in the memory and configured for execution by the one or more processors.

According to one embodiment of the present disclosure, the second input/output interface 505 is a simple network management protocol (SNMP) interface or a CPE WAN management protocol (TR069) interface. In another embodiment of the present disclosure, the fifth input data 508 is a simple network management protocol data and the sixth input data 518 is the same as the fifth input data 508.

According to another embodiment of the present disclosure, the second transceiving module 510 includes a converting module (not depicted). The converting modue is configured for converting the fifth input data 508 to the sixth input data 518, in which the sixth input data 518 are management information base data. In an example, the fifth input data 508 are Telnet data. The converting module is configured for converting the Telnet data to the sixth input data 518, which are management information base data.

In one embodiment of the present disclosure, the second transceiving module 510 includes at least one application programming interface (API). The application programming interface is configured for receiving the fifth input data 508, and for outputting the sixth input data 518.

In another embodiment of the present disclosure, the processing module 130 is further configured for converting the sixth input data 518 to the abovementioned fourth input data (not depicted) such that the electronic apparatus performs corresponding operations according to the fourth input data.

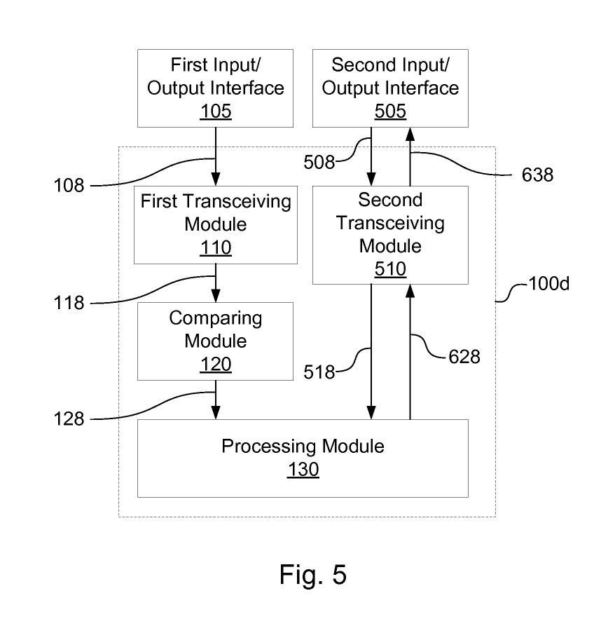

Reference is also made to FIG. 5. FIG. 5 is a schematic diagram of a management system 100d in accordance with one embodiment of the present disclosure. The management system 100d is applicable to an electronic apparatus. The abovementioned electronic apparatus can be a communication equipment, for example, a router, a modem or a switch, but is not limited thereto. Compared with the management system 100c illustrated in FIG. 4, in the present embodiment, the processing module 130 is further configured for converting fifth output data (not depicted) to sixth output data 628, and for outputting the sixth output data 628. The second transceiving module 510 is further configured for receiving the sixth output data 628, and for outputting seventh output data 638 to the corresponding second input/output interface 505 according to the sixth output data 628.

In one embodiment of the present disclosure, the he abovementioned electronic apparatus inquires data stored in the electronic apparatus according to the fourth input data, and outputs a inquiring result by utilizing the fifth output data such that a user or other electronic apparatuses could obtain the abovementioned inquiring result by utilizing the second input/output interface 505 to receive the seventh output result 638 corresponding to the abovementioned fifth output data. In another embodiment of the present disclosure, the abovementioned electronic apparatuses performs a firmware setup or a function setup according to the abovementioned fourth input data, and outputs a confirmation message or a status message by utilizing the abovementioned fifth output data. Therefore, a user or other electronic apparatuses could obtain the abovementioned confirmation message or status message by utilizing the second input/output interface 505 to receive the seventh output result 638 corresponding to the abovementioned fifth output data.

In another embodiment of the present disclosure, the second transceiving module 510 includes a converting module (not depicted). The abovementioned converting module is configured for converting the sixth output data 628 to the seventh output data 638, in which the sixth output data 628 are management information base data. In an example, the abovementioned converting module is configured for the sixth output data 628 (which are management information base data) to the seventh output data 638, which are Telnet data.

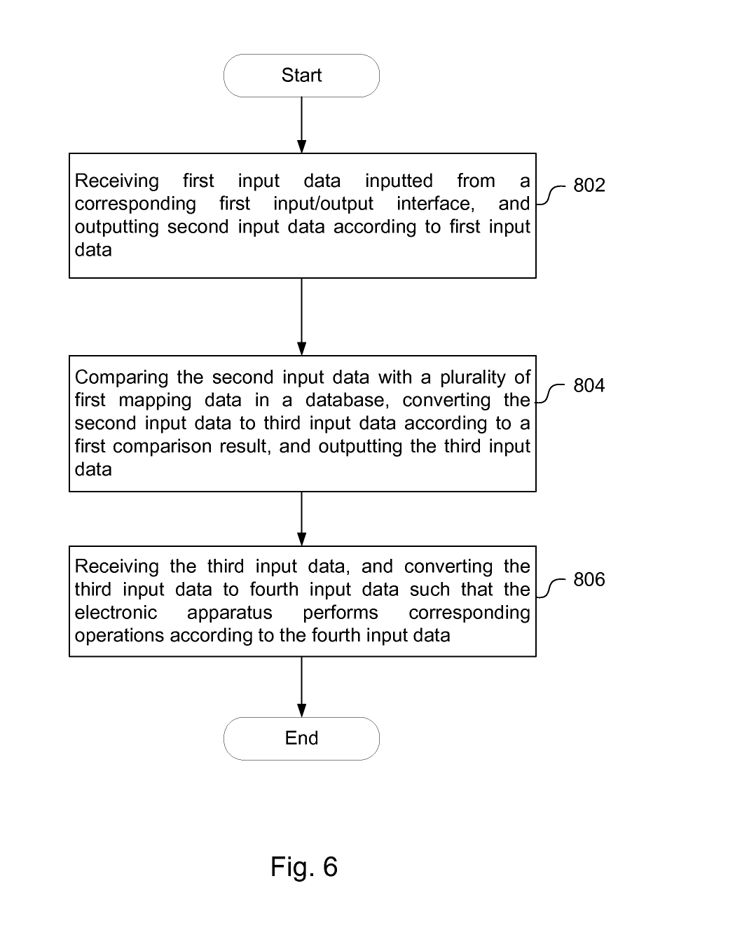

Reference is further made to FIG. 6. FIG. 6 is a flow chart of management method in accordance with one embodiment of the present disclosure. The management method may be implemented by the management system 100 illustrated in FIG. 1, but is not limited in this regard. For convenience and clarity, it is assumed that the management method is implemented by the management system 100 illustrated in FIG. 1.

In step 802, the first tranceiving module 110 receives first input data 108 inputted from a corresponding first input/output interface 105, and outputs second input data 118 according to the first input data 108.

In step 804, the comparing module 120 compares the second input data 118 with a plurality of first mapping data in a database, and converts the second input data 118 to third input data 128 according to a first comparison result, and outputs the third input data 128.

In step 806, the processing module 130 receives the third input data 128, and converts the third input data 128 to fourth input data such that the electronic apparatus performs corresponding operations according to the fourth input data.

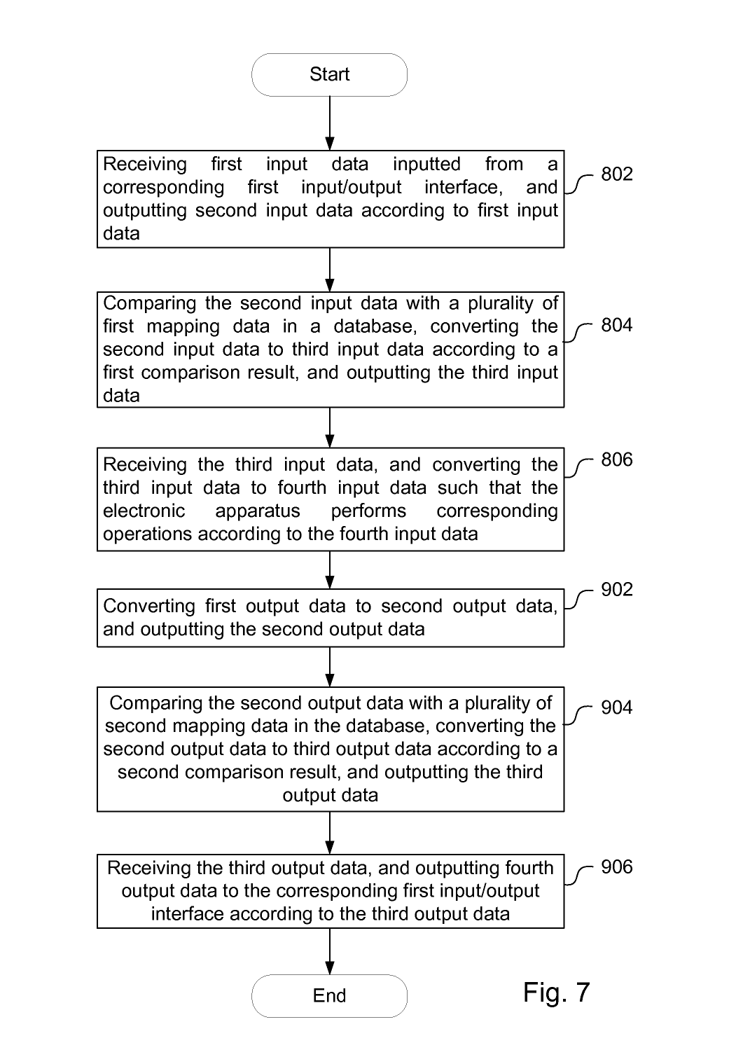

Reference is now made to FIG. 7. FIG. 7 is a flow chart of management method in accordance with one embodiment of the present disclosure. Compared with the management method illustrated in FIG. 6, the management method illustrated in FIG. 7 further includes steps 902, 904 and 906. The management method may be implemented by the management system 100a illustrated in FIG. 2, but is not limited in this regard. For convenience and clarity, it is assumed that the management method is implemented by the management system 100a illustrated in FIG. 2.

In step 902, the processing module 130 converts first output data to second output data 208, and outputting the second output data 208.

In step 904, the comparing module 120 compares the second output data 208 with a plurality of second mapping data in the database, converts the second output data 208 to third output data 218 according to a second comparison result, and outputs the third output data 218.

In step 906, the first transceiving module 110 receives the third output data 218, and outputs fourth output data 228 to the corresponding first input/output interface 105 according to the third output data 218.

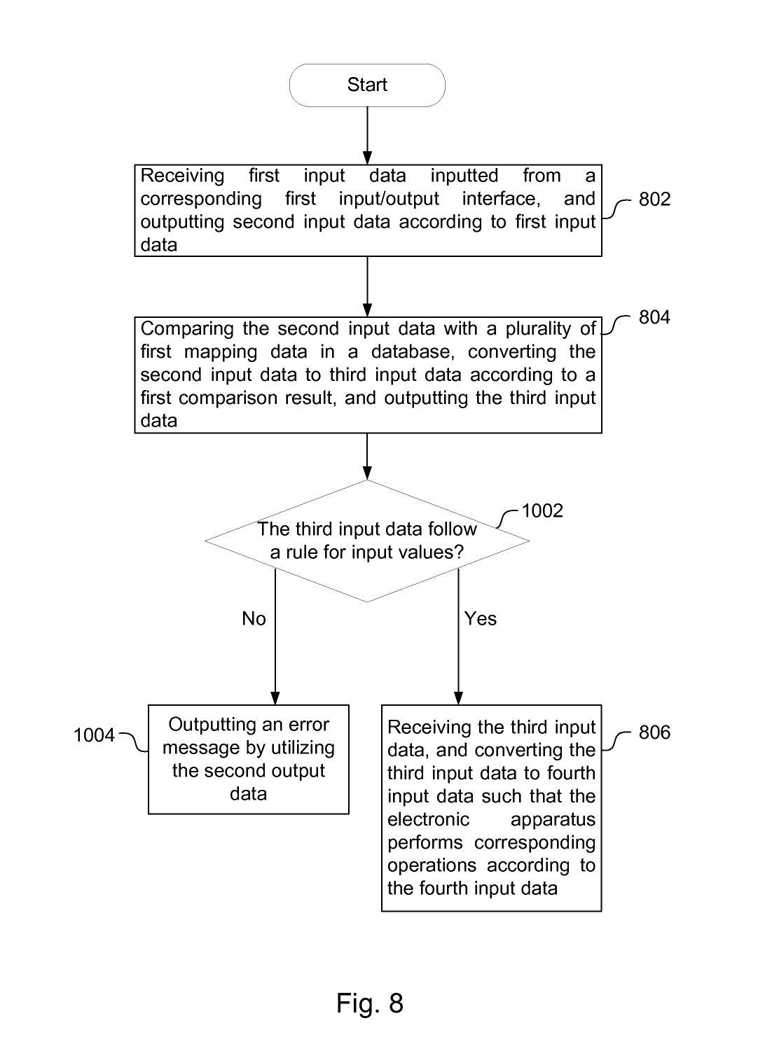

Reference is further made to FIG. 8. FIG. 8 is a flow chart of management method in accordance with one embodiment of the present disclosure. Compared with the management method illustrated in FIG. 6, the management method illustrated in FIG. 8 further includes steps 1002 and 1004. The management method may be implemented by the management system 100a illustrated in FIG. 2, but is not limited in this regard. For convenience and clarity, it is assumed that the management method is implemented by the management system 100a illustrated in FIG. 2.

In step 1002, a validation module (not depicted) included in the processing module 130 determines if the third input data 128 follow a rule for input values. If not, then in step 1004, the abovementioned validation module outputs an error message by utilizing the second output data 208.

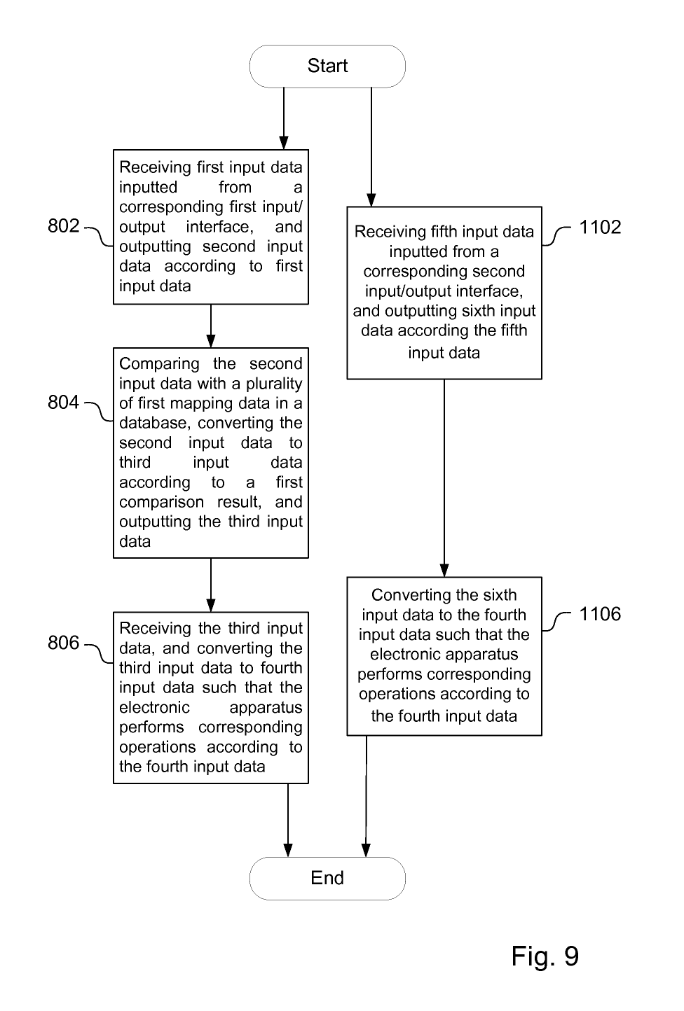

Reference is now made to FIG. 9. FIG. 9 is a flow chart of management method in accordance with one embodiment of the present disclosure. Compared with the management method illustrated in FIG. 6, the management method illustrated in FIG. 9 further includes steps 1102 and 1106. The management method may be implemented by the management system 100c illustrated in FIG. 4, but is not limited in this regard. For convenience and clarity, it is assumed that the management method is implemented by the management system 100c illustrated in FIG. 4.

In step 1102, the second transceiving module 510 receives fifth input data 508 inputted from a corresponding second input/output interface 505, and outputting sixth input data 518 according the fifth input data 508.

In step 1106, the processing module 130 converts the sixth input data 518 to the abovementioned fourth input data (not depicted) such that the electronic apparatus performs corresponding operations according to the fourth input data.

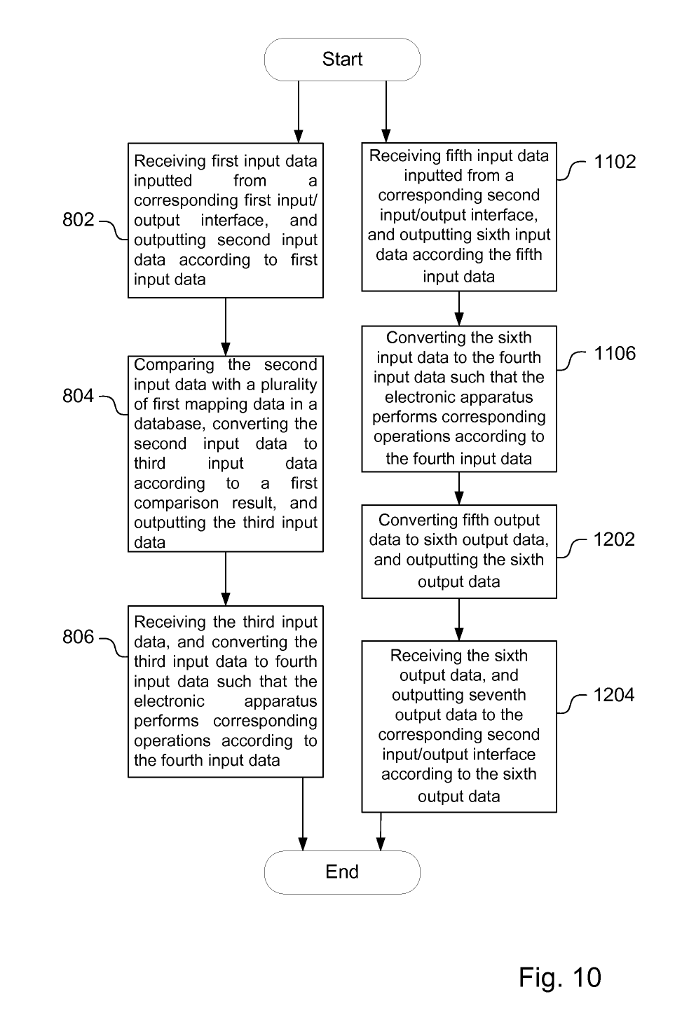

Reference is further made to FIG. 10. FIG. 10 is a flow chart of management method in accordance with one embodiment of the present disclosure. Compared with the management method illustrated in FIG. 9, the management method illustrated in FIG. 10 further includes steps 1202 and 1204. The management method may be implemented by the management system 100d illustrated in FIG. 5, but is not limited in this regard. For convenience and clarity, it is assumed that the management method is implemented by the management system 100d illustrated in FIG. 5.

In step 1202, the processing module 130 converts fifth output data (not depicted) to sixth output data 628, and outputs the sixth output data 628.

In step 1204, the second transceiving module 510 receives the sixth output data 628, and outputs seventh output data 638 to the corresponding second input/output interface 505 according to the sixth output data 628.

The above illustrations include exemplary operations, but the operations are not necessarily performed in the order shown. Operations may be added, replaced, changed order, and/or eliminated as appropriate, in accordance with the spirit and scope of various embodiments of the present disclosure.

By applying the management system disclosed in the present disclosure, the management program developed by software engineers could be used to manage or maintain electronic apparatus by utilizing different management protocols or interfaces. Moreover, the management system disclosed in the present disclosure could integrate different management protocols or interfaces and provide a single interface to correspond to the configuration manager of the system. Therefore, the complicity of the system core of the electronic apparatus can be reduced.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A management system applicable to an electronic apparatus, the management system comprising:
at least one first transceiving module, configured for receiving first input data inputted from a corresponding first input/output interface, and for outputting second input data according to the first input data;
a comparing module, configured for receiving the second input data, for comparing the second input data with a plurality of first mapping data in a database, for converting the second input data to third input data according to a first comparison result, and for outputting the third input data; and
a processing module, configured for receiving the third input data, and for converting the third input data to fourth input data such that the electronic apparatus performs corresponding operations according to the fourth input data.

2. The management system of claim 1, wherein the third input data and the fourth input data are management information base (MIB) data.

3. The management system of claim 1, wherein the processing module is further configured for converting first output data to second output data, and for outputting the second output data;
the comparing module is further configured for receiving the second output data, for comparing the second output data with a plurality of second mapping data in the database, for converting the second output data to third output data according to a second comparison result, and for outputting the third output data; and
the at least one first transceiving module is further configured for receiving the third output data, and for outputting fourth output data to the corresponding first input/output interface according to the third output data.

4. The management system of claim 3, wherein the processing module comprises:
a setup module, configured for transmitting the fourth input data to a configuration manager of the electronic apparatus such that the configuration manager adjusts a firmware setup or a function setup of the electronic apparatus according to the fourth input data; and
a reading module, configured for reading the first output data from the electronic apparatus by utilizing the configuration manager.

5. The management system of claim 3, wherein the first transceiving module comprises:
a converting module, configured for converting the first input data to the second input data, and for converting the third output data to the fourth output data, wherein the second input data and the third output data are described in JavaScript Object Notation (JSON) data-interchange format.

6. The management system of claim 3, wherein the processing module comprises:
a validation module, configured for determining if the third input data follow a rule for input values, if not, the validation module outputs an error message by utilizing the second output data.

7. The management system of claim 1, wherein the first input/output interface is a WEB interface, a command-line interface (CLI) or a Telnet interface.

8. The management system of claim 1, further comprising:
at least one second transceiving module, configured for receiving fifth input data inputted from a corresponding second input/output interface, and for outputting sixth input data according to the fifth input data, wherein the processing module is further configured for converting the sixth input data to the fourth input data.

9. The management system of claim 8, wherein the processing module is further configured for converting fifth output data to sixth output data, and for outputting the sixth output data; and
the second transceiving module is further configured for receiving the sixth output data, and for outputting seventh output data to the corresponding second input/output interface according to the sixth output data.

10. The management system of claim 9, wherein the second transceiving module comprises:
a converting module, configured for converting the fifth input data to the sixth input data, and for converting the sixth output data to the seventh output data, wherein the sixth input data and the sixth output data are management information base data.

11. The management system of claim 8, wherein the second transceiving module is a simple network management protocol (SNMP) interface or a CPE WAN management protocol (TR069) interface.

12. A management method applicable to an electronic apparatus, the management method comprising:
receiving first input data inputted from a corresponding first input/output interface, and outputting second input data according to the first input data;
comparing the second input data with a plurality of first mapping data in a database, converting the second input data to third input data according to a first comparison result, and outputting the third input data; and
receiving the third input data, and converting the third input data to fourth input data such that the electronic apparatus performs corresponding operations according to the fourth input data.

13. The management method of claim 12, wherein the third input data and the fourth input data are management information base data.

14. The management method of claim 12 further comprising:
converting first output data to second output data, and outputting the second output data;
comparing the second output data with a plurality of second mapping data in the database, converting the second output data to third output data according to a second comparison result, and outputting the third output data; and
receiving the third output data, and outputting fourth output data to the corresponding first input/output interface according to the third output data.

15. The management method of claim 12, wherein receiving the third input data, and converting the third input data to the fourth input data such that the electronic apparatus performs corresponding operations according to the fourth input data further comprises:
transmitting the fourth input data to a configuration manager of the electronic apparatus such that the configuration manager adjusts a firmware setup or a function setup of the electronic apparatus according to the fourth input data.

16. The management method of claim 14, wherein receiving the first input data inputted from the corresponding first input/output interface, and outputting the second input data according to the first input data further comprises:
converting the first input data to the second input data, wherein the second input data are described in JavaScript Object Notation data-interchange format; and
receiving the third output data, and outputting the fourth output data to the corresponding first input/output interface according to the third output data further comprises:
converting the third output data to the fourth output data, wherein the third output data are described in JavaScript Object Notation data-interchange format.

17. The management method of claim 14 further comprising:
determining if the third input data follow a rule for input values, and if not, outputting an error message by utilizing the second output data.

18. The management method of claim 12 wherein the first input/output interface is a WEB interface, a command-line interface or a Telnet interface.

19. The management method of claim 12 further comprising:
receiving fifth input data inputted from a corresponding second input/output interface, and outputting sixth input data according the fifth input data; and
converting the sixth input data to the fourth input data such that the electronic apparatus performs corresponding operations according to the fourth input data.

20. The management method of claim 19 further comprising:
converting fifth output data to sixth output data, and outputting the sixth output data; and
receiving the sixth output data, and outputting seventh output data to the corresponding second input/output interface according to the sixth output data.

21. The management method of claim 19, wherein the second transceiving module is a simple network management protocol interface or a CPE WAN management protocol interface.
